(19) United States
(12) Patent Application Publication
(10) Pub. No.: US 2011/0127784 A1
(43) Pub. Date: Jun. 2, 2011

(54) DEVICE FOR COLLECTION OF SOLID WASTS OF CANINE ORIGIN

(76) Inventor: Josep Sarmiento Gavalda, Sant Joan Despi (ES)

(21) Appl. No.: 12/999,806

(22) PCT Filed: May 6, 2009
(86) PCT No.: PCT/ES2009/000239

§ 371 Date: Feb. 11, 2011

(30) Foreign Application Priority Data
Jun. 20, 2008 (ES) U 200801327

(51) Int. Cl. A01K 29/00

(52) U.S. Cl. 294/1.3

(57) ABSTRACT

The present invention refers to an improved device for the collection of solid wastes or deposits of canine or similar origin from the ground, and more specifically to those which are of a disposable nature formed by a bag to house the waste incorporating a mechanism for easy sealability thereof.

### SECTOR OF THE ART

This invention relates to an improved device for picking up from ground solid waste or excrement of canine origin or the like, and more particularly those that are disposable and are made up of a bag for housing the waste, which includes a mechanism for closing it easily.

### PURPOSE OF INVENTION

The purpose of this invention is to provide an improved device for picking up from ground solid waste of canine origin or the like, which is disposable, occupying a minimum amount of space when folded before being used, that allows the user and dog owner not to come into contact with the waste (not even through the bag), and finally which enables picking up said waste effectively in the bag so that it can be placed in a bin or container.

### STATE OF THE ART

Several tools or devices intended for picking up dog waste exist in the market, and can therefore be considered state of the art, and which are intended to help dog owners keep streets, pavements, parks and gardens clean and therefore abide by municipal by laws.

The tools currently known for this purpose have different shapes, but basically they are accessories that are adapted to facilitate the positioning and/or opening of a conventional bag and enable the user to avoid bending down to the ground excessively, to remove the waste.

However, this type of auxiliary devices are very cumbersome and are not disposable, which makes the use thereof reduced and ineffective.

### DESCRIPTION OF THE INVENTION

This invention comprises mainly a bag made from paper, plastic or similar materials, the mouth of which has a perimeter edging in the inside of which there is a cord like a slider, the ends of which are joined by a sliding knot, with one or both ends of the cord coming through the bag via a hole in the edging. One or both ends of the cord come out through the exit hole, and then said end(s) of the knot are joined to a gripping-foot element. On the end opposite to said cord exit hole, one or various elastic bands are provided which at one of their ends are joined to respective points of the edging and at the other one of their ends are joined to another gripping-foot element, with the two support-foot elements being adapted so that the user treads on one of the support-foot elements with each foot, and therefore holds the bag by the two ends thereof, thereby allowing its mouth to be closed appropriately by tightening it.

At the end part of the end(s) of the cord a gripping element is provided, adapted so that the user can take it in their by hand and by pulling it upwards produces the tightening of the bag, which is arranged around the waste and above it, and with said tightening effect underneath, the perfect closure of the bag is obtained, with the waste inside it.

The two support-foot elements could be covers made of plastic or an equivalent material (such as cardboard) through the inside of which the cord or elastic band passes; or they could be rammers made up of a flat element that is not very thick and which is placed on the ground; or they could be a combination of a cover and a rammer, one at each end of the bag.

Said rammer could have in addition to a flat base element another element joined in angular fashion to said base element, so that with this angular arrangement, on the one hand, a final sweeping of the waste remains that may have not been picked up is achieved, and on the other hand, it prevents the user's shoe from becoming stained by undesired contact with the waste. Said rammer could be made from various materials, for example of the cellulose type for an effective final sweep and the absorption thereof.

The gripping element could be any shape that allows the user to take said gripping element with one hand or with an auxiliary element, and pull it. According to one of the possible embodiments, the gripping element will be a ring or a handle. The auxiliary element could be for example a telescopic configuration extendible element provided at the end thereof with a hook for picking up the gripping element, and this way the user avoids having to bend down to close the bag.

With this advantageous arrangement, in order to pick up the waste from the ground, the user places the bag with its mouth towards the ground, over the waste, treads with one foot and presses one of the support-foot elements against the ground, and with the other foot, treads and presses the other gripping-foot element against the ground. Then the user takes the support element and pulls it upwards, so that the cord also pulls upwards and consequently the edging of the bag mouth is pulled tight towards the end of the bag corresponding to the location of the support element.

When closing the bag mouth, the waste is picked up from the ground, then the user releases their feet from the two support-foot elements, and can finish picking up the remainder of the waste that may still be on the ground by slightly moving the rammer with their foot. Finally, the user turns the bag around and places the whole unit in the corresponding bin or container.

In addition, the edging that surrounds the whole perimeter border of the bag mouth could include a perimeter inward extension, for example skirting, adapted to help drag the waste more efficiently from the ground towards the inside of the bag.

Alternatively, the elastic band(s) could be replaced with gathering line(s) made on one or both ends of the bag, adapted so that once the gathering operation is produced, they gradually weaken and break, exercising the same function as the elastic band(s).

Alternatively, the sliding cord could be replaced by two cords and in this case the edging will have two exit holes, one on each side of the bag: the first cord will come out through one of the exit holes, and the second cord will come out through the other exit hole, with the end of the first cord being supported with a sliding knot to the second cord near the second exit hole, and with the end of the second cord being supported with a sliding knot to the first cord near the first exit hole. In this case, respective gripping means will be arranged on each end of the two cords, so that the user will take both gripping elements in their hand and by pulling them upwards will close the bag mouth.

In both embodiments (one single cord with elastic band(s) or two cords), the sliding knot(s) will be of the flange type, in other words that they will allow the cord to slide only in one direction.

Other details and characteristics will become apparent during the description given below, with reference to the drawings accompanying this specification, which show an illustrative, non-limiting example, of a practical embodiment of the invention.

### DESCRIPTION OF THE FIGURES

FIG. 1 is a top plan view of a first embodiment of the device for picking up dog waste (10).

FIG. 2 is a front elevation view of the device for picking up dog waste (10) in FIG. 1.

FIG. 3 is a top plan view of a second embodiment of the device for picking up dog waste (10).

FIG. 4 is a top plan view of a third embodiment of the device for picking up solid dog waste (10).

### DESCRIPTION OF ONE OF THE EMBODIMENTS OF THE INVENTION

In one of the preferred embodiments of the object of this invention, the improved device for picking up solid waste (10) of canine origin is made up of a bag (10) provided with a mouth with a perimeter edging (12) inside which a cord (15) is housed which acts as a slider, with both ends of cord (15) being joined by a sliding knot (22), with just one of the end parts of cord (15) coming out of edging (12) through hole (21) in said edging (12), see FIG. 1. In this case, the end part of cord (15) near said exit hole (21) is housed inside a cover (20), with a ring (16) being arranged at the end of said end part and attached thereto, which acts as a support or gripping element.

On the other side of the bag (11) opposite hole (21) respective elastic bands (14) are joined to the outer surface of said bag (11), which are joined firmly at their opposite ends to an angular rammer (13) formed by two planes at an angle (18-19).

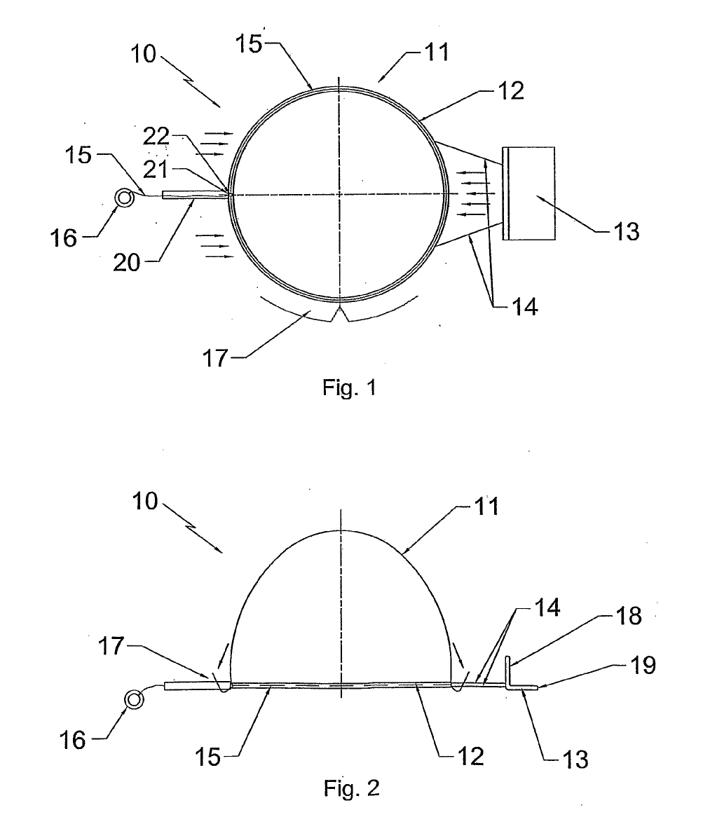

Advantageously, perimeter skirting (17) has been designed all around the perimeter of the mouth of the bag (11), which collapse on said mouth in the direction indicated by the arrows in FIG. 2, thereby avoiding that when waste remains on the mouth of said skirting, it comes into contact with the user.

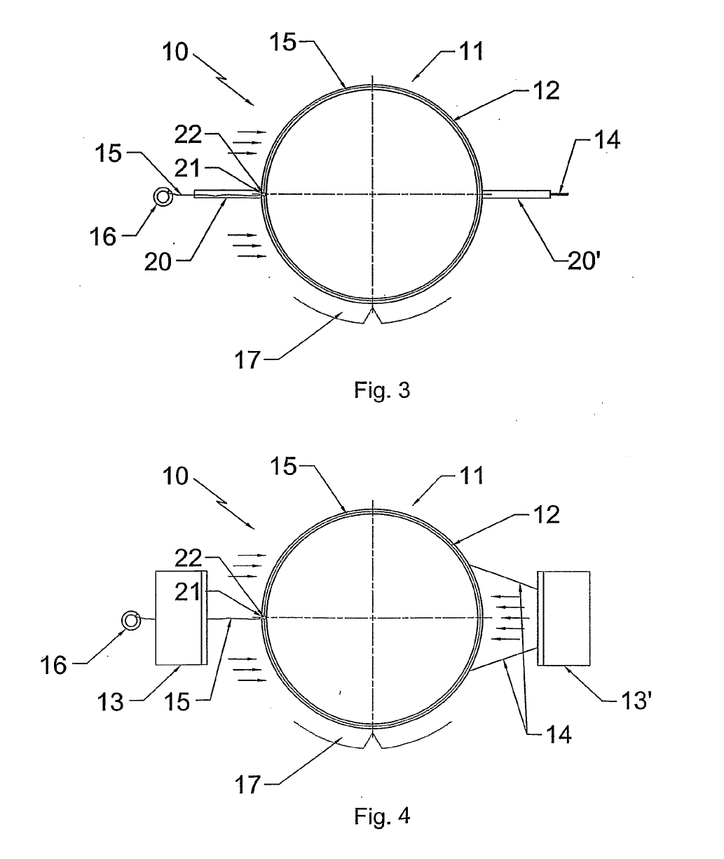

The two support-foot elements could be a cover (20) and a rammer (13) (see FIG. 1), they could be respective covers (20, 20′) through the inside of which the cord or elastic band passes (see FIG. 3), or they could be respective rammers (13, 13′) formed by an angular element that is positioned on the ground (see FIG. 4).

The recommended device, operates as follows: the user places bag (11), as shown in FIG. 1, in other words with the mouth facing the ground and covering the excrement, then he places rammer (13) in the position indicated in FIG. 1, taking care that bands (14) that join rammer (13) to the bag (11) are conveniently extended, next the user places one foot on rammer (13) and the other on cover (20). Then the user grips ring (16) joined to the free end of cord (15) and pulls, so that cord (15) tightens the mouth of bag (11) with said mouth moving in the direction indicated by the arrows in FIG. 1. When it closes, the mouth of bag (11) drags the waste from the ground, then the user releases their feet from rammer (13) and cover (20) respectively, and can finish picking up the remainder of the waste that may still be on the ground by slightly moving rammer (13) with their foot. Finally, the user turns the whole device (10) around and places it in the corresponding bin or container.

Having sufficiently described this invention in correspondence with the attached figures, it is easy to understand that any modifications to detail that are considered convenient could be introduced therein, providing this does not alter the essential nature of the invention that is summarised in the following claims.

1. A device for picking up solid dog waste of the type that are made up of a bag that is open at one of its ends, the mouth of which has a perimeter edging through the inside of which a cord is arranged like a slider, the both ends of the cord being joined by a sliding knot and with one or both of the ends of the cord coming out of the bag through a hole in the edging, characterised in that on the outside of the edging the end or both ends of the cord are joined to a gripping-foot element; and that in the end opposite said cord exit hole one or various elastic bands are provided which are joined to another support-foot element, with said two support-foot elements being adapted so that the user treads on one support-foot element with each foot so as to hold the bag by its two ends and therefore allow its mouth to be closed appropriately by tightening it; and that attached to the end or ends of the cord a gripping element is arranged, which is adapted so that the user can take it in their hand and pull it upwards to tighten the mouth of the bag, which is arranged surrounding the waste from above, and thereby manages to close the bag with the waste inside it.

2. The device for picking up solid dog waste according to claim 1, characterised in that the two support-foot elements are covers made of plastic or an equivalent material inside which the cord or elastic band passes or rammers made up of a flat element that is not too thick and which is laid on the ground or a combination of a cover and a rammer, one at each end of the bag.

3. The device for picking up solid dog waste according to claim 2, characterised in that the rammer has in addition to a flat base element an other element joined in angular fashion to said base element, so that with this angular arrangement, on the one hand, a final sweeping of the waste remains that may have not been picked up is achieved, and on the other hand, it prevents the user's shoe from becoming stained by undesired contact with the waste.

4. The device for picking up solid waste according to claim 1, characterised in that the gripping element is a ring or a handle.

5. The device for picking up solid dog waste according to claim 1, characterised in that in addition the edging surrounding the whole perimeter of the mouth of the bag includes a perimeter inward extension adapted to help drag the waste from the ground towards the inside of the bag.

6. The device for picking up solid dog waste according to claim 1, characterised in that the elastic bands are replaced by gathering lines on the opposite end to the cord exit hole of the bag, so that once the gathering lines are pulled they weaken breaking the bag along said gathering lines.
